(19) United States
(12) Patent Application Publication
(10) Pub. No.: US 2015/0264330 A1
(43) Pub. Date: Sep. 17, 2015

(54) SOLID STATE IMAGING DEVICE AND CAMERA SYSTEM

(71) Applicant: Kabushiki Kaisha Toshiba, Minato-ku (JP)

(72) Inventors: Takayuki OGASAHARA, Yokohama (JP); Katsuo IWATA, Yokohama (JP); Kazuhiro NAGATA, Yokohama (JP); Ninao SATO, Mitaka (JP)

(73) Assignee: Kabushiki Kaisha Toshiba, Minato-ku (JP)

(21) Appl. No.: 14/615,721

(22) Filed: Feb. 6, 2015

(30) Foreign Application Priority Data
Mar. 13, 2014 (JP) 2014-050576

(51) Int. Cl. H04N 9/73; H04N 9/64; H04N 9/04

(52) U.S. Cl. CPC H04N 9/735; H04N 9/045; H04N 9/646

(57) ABSTRACT

According to one embodiment, a solid state imaging device has a color mixture correction circuit. The color mixture correction circuit is provided with an adjustment circuit. The adjustment circuit adjusts a relationship between a signal level and a wavelength of light of each color component from an image sensor based on a first correction coefficient. The first correction coefficient is a correction coefficient for color mixture correction. A second correction coefficient is a correction coefficient corresponding to a sensitivity difference among color pixels. The adjustment circuit adjusts the signal level of each of the color components based on the second correction coefficient, which has been read according to a distance from center of an image.

### CROSS-REFERENCE TO RELATED APPLICATIONS

This application is based upon and claims the benefit of priority from Japanese Patent Application No. 2014-050576, filed on Mar. 13, 2014; the entire contents of which are incorporated herein by reference.

### FIELD

Embodiments described herein relate generally to a solid state imaging device and a camera system.

### BACKGROUND

In recent years, thinning of a camera module is progressing. Accompanied by this, an inclination of a main light beam entering an image sensor from an imaging lens tends to be larger in the camera module. In the image sensor, the inclination of the main light beam becomes prominent at a position closer to a diagonal end. As more light diagonally enters the image sensor, more leakage of the light occurs into a pixel adjacent to a pixel that has received the light. By the light gathering near a border of the pixels, an electron, which has been generated by photoelectric conversion, may cross the border and may be leaked into the adjacent pixel. Such optical and electrical crosstalk between the adjacent pixels is referred to as color mixture. The color mixture is a cause of deterioration in color reproducibility. It is desired that a solid state imaging device be capable of suppressing influence of the color mixture that occurs in the image sensor.

A scaling technique has been known as a first method of decreasing the inclination of an incidence angle in the image sensor. In the scaling technique, the incidence angle is corrected by adjusting a position of a microlens on a pixel. As the thinning of the camera module progresses, it becomes difficult to sufficiently correct the inclination of the incidence angle in the image sensor by using the first method.

As a second method of decreasing the inclination of the incidence angle in the image sensor, there has been known a method of making a color filter on a pixel thinner. As the color filter is made thinner, however, color light, which is to be blocked by the color filter, is more easily leaked into a side of a pixel. Color separation by the color filter becomes insufficient, whereby the color reproducibility is deteriorated.

### BRIEF DESCRIPTION OF THE DRAWINGS

FIG. 1 is a block diagram illustrating a schematic configuration of a solid state imaging device according to an embodiment;

FIG. 2 is a block diagram illustrating a schematic configuration of a camera system provided with the solid state imaging device illustrated in FIG. 1;

FIG. 3 is a block diagram illustrating a configuration of a color mixture correction circuit illustrated in FIG. 1;

FIG. 4 is a view illustrating an example of calculating a color component value before a color mixture correction according to the embodiment;

FIG. 5 is a view illustrating a change in an output characteristic in the color mixture correction by the color mixture correction circuit illustrated in FIG. 3;

FIG. 6 is a view illustrating a sensitivity difference between an R component and a G component within an image obtained by an image sensor illustrated in FIG. 1;

FIG. 7 is a view illustrating a sensitivity difference between a B component and the G component within the image obtained by the image sensor illustrated in FIG. 1; and

FIG. 8 is a view illustrating a sensitivity difference between a Gr pixel and a Gb pixel provided to the image sensor illustrated in FIG. 1.

### DETAILED DESCRIPTION

In general, according to one embodiment, a solid state imaging device has an image sensor and a color mixture correction circuit. The image sensor is provided with color pixels. The image sensor images an object image. The color mixture correction circuit performs a color mixture correction on the object image. The color mixture correction circuit is provided with an adjustment circuit and a memory. The adjustment circuit adjusts a relationship between a signal level and a wavelength of light of each color component from the image sensor based on a first correction coefficient. The first correction coefficient is a correction coefficient for the color mixture correction. The memory holds the first correction coefficient and a second correction coefficient. The second correction coefficient is a correction coefficient according to a sensitivity difference among the color pixels. The memory holds the second correction coefficient set for each range of distance from center of an image. The adjustment circuit adjusts the signal level of each of the color components based on the second correction coefficient, which has been read according to the distance.

Exemplary embodiments of a solid state imaging device and a camera system will be explained below in detail with reference to the accompanying drawings. The present invention is not limited to the following embodiments.

### Embodiment

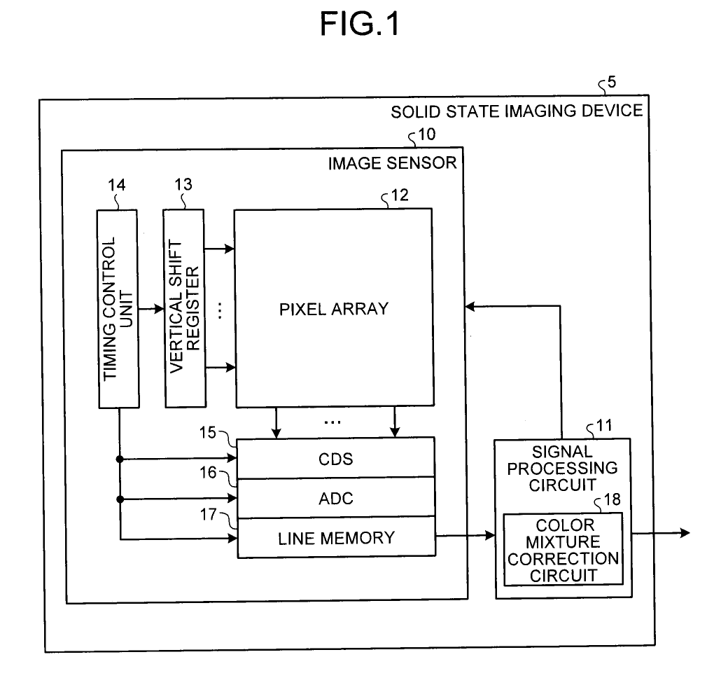

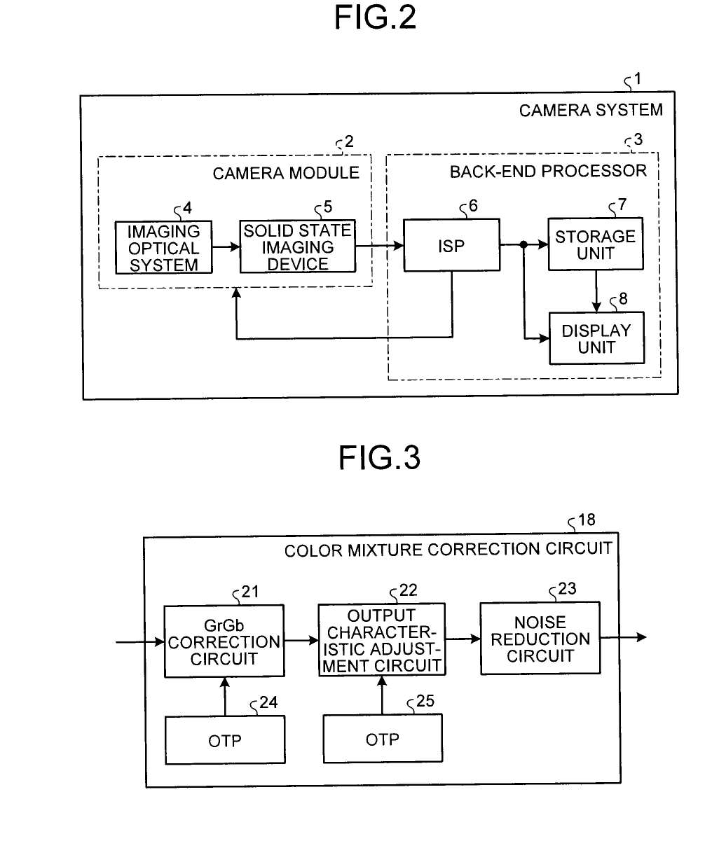

FIG. 1 is a block diagram illustrating a schematic configuration of the solid state imaging device according to an embodiment. FIG. 2 is a block diagram illustrating a schematic configuration of the camera system provided with the solid state imaging device illustrated in FIG. 1.

A camera system 1 is an electronic device provided with a camera module 2. The camera system 1 is, for example, a portable terminal with a camera. The camera system 1 may be any electronic device provided with the camera module 2 such as a digital still camera and a digital video camera.

The camera system 1 includes the camera module 2 and a back-end processor 3. The camera module 2 includes an imaging optical system 4 and a solid state imaging device 5. The back-end processor 3 includes an image signal processor (ISP) 6, a storage unit 7, and a display unit 8.

The imaging optical system 4 takes in light from an object. The imaging optical system 4 performs image formation of an object image. The solid state imaging device 5 images the object image. The ISP 6 performs signal processing on an image signal obtained through imaging by the solid state imaging device 5. The storage unit 7 stores an image on which the signal processing has been performed by the ISP 6. The storage unit 7 outputs the image signal to the display unit 8 in response to operation and the like by a user.

The solid state imaging device 5 is provided with an image sensor 10, which is an imaging element, and a signal processing circuit 11, which is an image processing device. The image sensor 10 images the object image. The image sensor 10 is, for example, a CMOS image sensor. The image sensor 10 includes a pixel array 12, a vertical shift register 13, a timing control unit 14, a correlated double sampling unit (CDS) 15, an analog-digital conversion unit (ADC) 16, and a line memory 17.

The pixel array 12 is provided in an imaging region of the image sensor 10. The pixel array 12 is provided with pixels arranged in an array in a horizontal direction and a vertical direction. Each of the pixels is provided with a photodiode, which is a photoelectric conversion element. The photoelectric conversion element generates signal charge according to quantity of incident light. Each of the pixels accumulates the signal charge according to the quantity of the incident light. On a side of incidence of each of the pixels, a color filter (not illustrated) according to color arrangement is provided.

The pixel array 12 is provided with color pixels that detect light of each of the color components. The color pixels respectively detect color light, which has transmitted through the color filter. The color pixels constitute a Bayer array.

The Bayer array is constituted of four pixels of Gr, R, Gb, and B as a unit. The red (R) pixel detects a red color component. The blue (B) pixel detects a blue color component. The Gr pixel, which is a first green pixel, is a green (G) pixel that detects a green color component. The Gr pixel is adjacent to the R pixel in a horizontal direction. The Gb pixel, which is a second green pixel, is a green (G) pixel that detects the green color component. The Gb pixel is adjacent to the B pixel in the horizontal direction.

The timing control unit 14 controls reading of a signal from a plurality of pixels. The timing control unit 14 supplies a vertical synchronizing signal, which instructs timing to read the signal from each of the pixels in the pixel array 12, to the vertical shift register 13. The timing control unit 14 supplies a timing signal, which instructs drive timing, to each of the CDS 15, the ADC 16, and the line memory 17.

In response to the vertical synchronizing signal from the timing control unit 14, the vertical shift register 13 selects a pixel within the pixel array 12 for each horizontal line. The vertical shift register 13 outputs a reading signal to each of the pixels of the selected horizontal line. The pixel to which the reading signal has been input from the vertical shift register 13 outputs the accumulated signal charge. The pixel array 12 outputs the signal from the pixel to the CDS 15 through a vertical signal line.

The CDS 15 performs correlated double sampling processing for decreasing a fixed pattern noise on the signal from the pixel array 12. The ADC 16 converts an analog type signal into a digital type signal. The line memory 17 accumulates the signal from the ADC 16. The image sensor 10 outputs the signal that has been accumulated in the line memory 17.

The signal processing circuit 11 performs various signal processing on an image signal from the image sensor 10. The signal processing circuit 11 is provided with a color mixture correction circuit 18. The color mixture correction circuit 18 performs the color mixture correction on the object image.

The signal processing circuit 11 performs various signal processing other than the color mixture correction as well. The signal processing circuit 11 performs defect correction, gamma correction, noise reduction processing, lens shading correction, white balance adjustment, distortion correction, resolution restoration, and the like. In FIG. 1, in a configuration of the signal processing circuit 11, illustration of a constitutional element other than the color mixture correction circuit 18 is omitted.

The solid state imaging device 5 outputs the image signal, on which the signal processing has been performed in the signal processing circuit 11, to outside of a chip. Based on data, on which the signal processing has been performed in the signal processing circuit 11, the solid state imaging device 5 performs feedback control on the image sensor 10.

In the camera system 1, at least any of various signal processing, which has been described as being performed by the signal processing circuit 11 in this embodiment, may also be performed by the ISP 6 of the back-end processor 3. In the camera system 1, at least any of the various signal processing may also be performed by both of the signal processing circuit 11 and the ISP 6. The signal processing circuit 11 and the ISP 6 may also perform signal processing other than the signal processing described in this embodiment. The ISP 6 may also be provided with the color mixture correction circuit 18.

FIG. 3 is a block diagram illustrating a configuration of the color mixture correction circuit illustrated in FIG. 1. The color mixture correction circuit 18 performs the color mixture correction for optical and electrical crosstalk through the signal processing on the image signal. The color mixture correction circuit 18 is provided with a GrGb correction circuit 21, an output characteristic adjustment circuit 22, a noise reduction circuit 23, and OTPs 24 and 25.

The GrGb correction circuit 21 is a green correction circuit for correcting a signal level of a green component. The GrGb correction circuit 21 corrects the signal level of the green component according to a sensitivity difference between the Gr pixel and the Gb pixel.

The output characteristic adjustment circuit 22 adjusts a relationship between the signal level and wavelength of light of each color component from the image sensor 10. The relationship between the signal level and the wavelength of light of each of the color component is referred to as an “output characteristic” as appropriate. The output characteristic adjustment circuit 22 performs the color mixture correction and a color sensitivity difference correction.

The noise reduction circuit 23 performs the noise reduction processing on the object image. The noise reduction circuit 23 is mainly provided with a function of reducing a noise component, which increases with the color mixture correction by the output characteristic adjustment circuit 22.

OTPs (One Time Programmable memory) 24 and 25 are coefficient holding circuits. The OTP 24, which is a second memory, holds a third correction coefficient (green pixel sensitivity difference correction coefficient). The third correction coefficient is a correction coefficient corresponding to the sensitivity difference between the Gr pixel and the Gb pixel. The GrGb correction circuit 21 corrects the signal level of the green component based on the third correction coefficient read from the OTP 24.

The OTP 25, which is a first memory, holds the first correction coefficient (color mixture correction coefficient) and the second correction coefficient (color sensitivity difference correction coefficient). The first correction coefficient is a correction coefficient for the color mixture correction. The second correction coefficient is a correction coefficient corresponding to a sensitivity difference between the R, G, and B pixels, which are the color pixels. Based on the first correction coefficient read from the OTP 25, the output characteristic adjustment circuit 22 adjusts a relationship between the signal level and the wavelength of light of each of the color components from the image sensor 10. Based on the second correction coefficient read from the OTP 25, the output characteristic adjustment circuit 22 adjusts the signal level of each of the color components.

The output characteristic adjustment circuit 22 performs arithmetic using the following equation as the color mixture correction. The first correction coefficient is a 3×3 coefficient matrix, in which Aᵢⱼ (i=1, 2, and 3; and j=1, 2, and 3) is a coefficient. Note that (R, G, B) is a color component value after the color mixture correction, and (r, g, b) is a color component value before the color mixture correction.

$$( \begin{matrix}R \\ G \\ B\end{matrix} ) = ( \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ) ( \begin{matrix}r \\ g \\ b\end{matrix} )$$

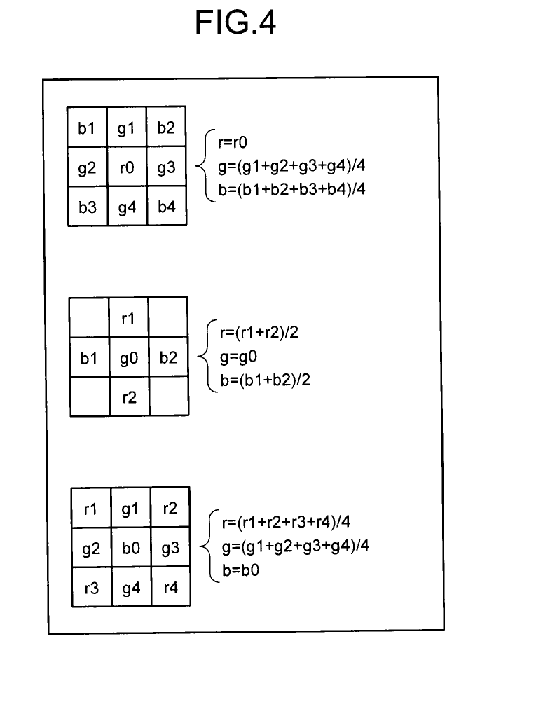

FIG. 4 is a view illustrating an example of calculating the color component value before the color mixture correction according to the embodiment. The output characteristic adjustment circuit 22 calculates each of the color component values of each of the pixels. The color component value of the R pixel is calculated by using a signal value of the pixels included in a 3×3 pixel block centering on the R pixel. A color component value r is a signal value r0 of the central R pixel. A color component value g is an average value of signal values g1, g2, g3, and g4 of four G pixels around the R pixel. A color component value b is an average value of signal values b1, b2, b3, and b4 of four B pixels around the R pixel.

The color component value of the G pixel is calculated by using the signal value of the pixel included in a 3×3 pixel block centering on the G pixel. The color component value g is a signal value g0 of the central G pixel. The color component value r is an average value of signal values r1 and r2 of two R pixels around the G pixel. The color component value b is an average value of signal values b1 and b2 of two B pixels around the G pixel.

The color component value of the B pixel is calculated by using the signal value of the pixel included in a 3×3 pixel block centering on the B pixel. The color component value b is a signal value b0 of the central B pixel. The color component value r is an average value of signal values r1, r2, r3, and r4 of four R pixels around the B pixel. The color component value g is an average value of the signal values g1, g2, g3, and g4 of four G pixels around the B pixel. Note that a method of calculating each of the color component values is not to be limited to the methods described in this embodiment. The output characteristic adjustment circuit 22 may calculate each of the color component values by any method.

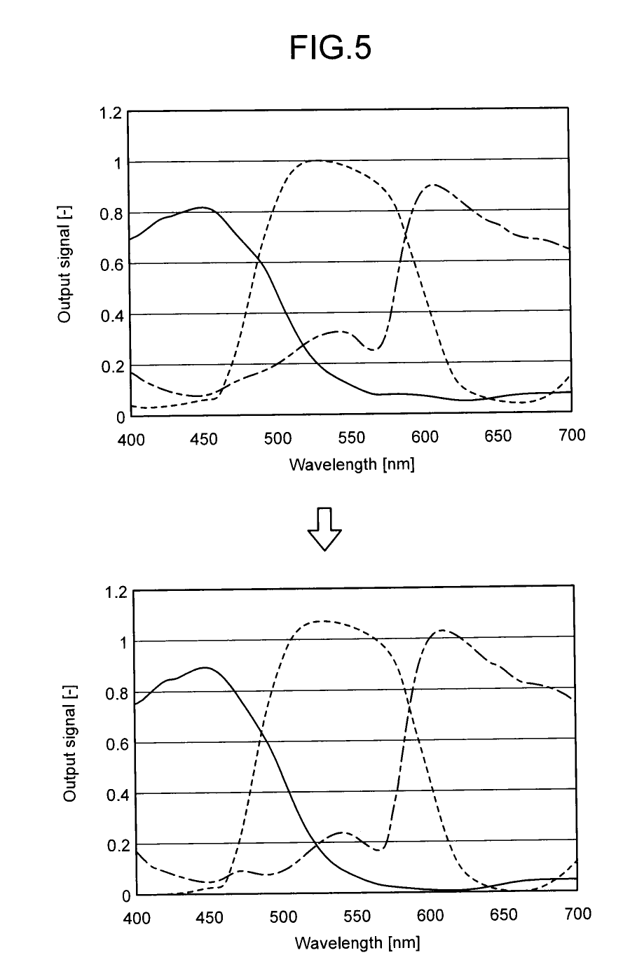

FIG. 5 is a view illustrating a change in the output characteristic by the color mixture correction in the color mixture correction circuit illustrated in FIG. 3. Each of curved lines illustrated in a graph represents a relationship between signal output and wavelength of each of the color components. A graph with a long dashed short dashed line represents an output characteristic of an R component. A graph with a broken line represents an output characteristic of a G component. A graph with a solid line represents an output characteristic of a B component.

An output characteristic of the image sensor 10 is, in a case where color mixture is caused, changed such that output is high in a wavelength region represented as a skirt portion of the graph. The output characteristic is also changed such that the output is low at a peak of the graph. The output characteristic adjustment circuit 22 performs processing for decreasing this change in the output characteristic as the color mixture correction. By performing the color mixture correction, the output characteristic adjustment circuit 22 decreases the output in the skirt portion of the graph as well as improves the output at the peak thereof.

The OTP 25 holds a set of the first correction coefficient. The output characteristic adjustment circuit 22 performs the above-described arithmetic based on the first correction coefficient read from the OTP 25.

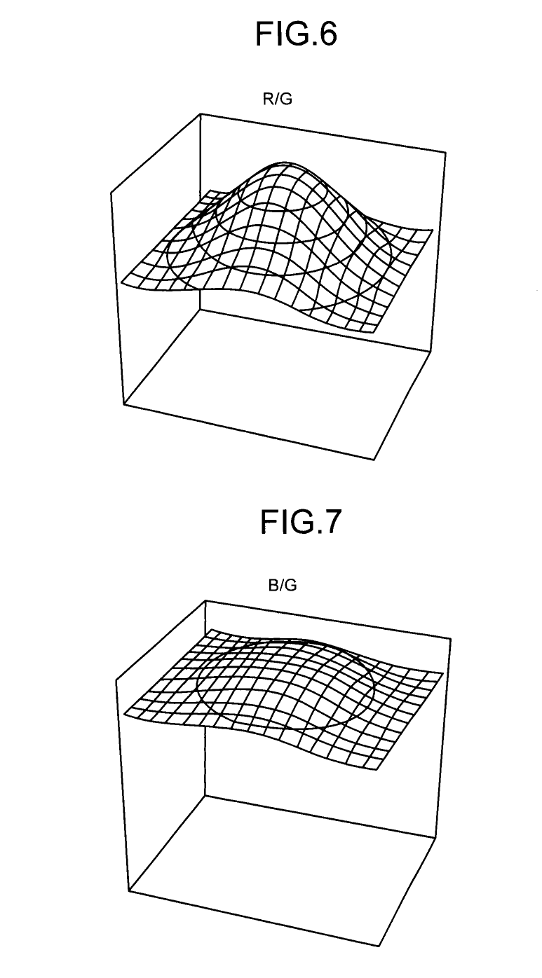

FIG. 6 is a view illustrating a sensitivity difference between the R component and the G component within an image obtained by the image sensor illustrated in FIG. 1. An illustrated curved surface represents distribution of sensitivity of the R component based on sensitivity of the G component. A position on the image is represented in a horizontal direction. The sensitivity is represented in a height direction. The sensitivity of the R component relative to the G component becomes low as it is away from a center of the image.

FIG. 7 is a view illustrating a sensitivity difference between the B component and the G component within the image obtained by the image sensor illustrated in FIG. 1. An illustrated curved surface represents a distribution of the sensitivity of the G component based on sensitivity of the B component. The sensitivity of the B component relative to the G component becomes low as it is away from the center of the image. Note, however, that a degree of the sensitivity of the B component becoming low relative to the G component is smaller than a degree of the sensitivity of the R component becoming low relative to the G component.

The OTP 25 holds a table of the second correction coefficient, which is set for each range of distance from center of the image. The output characteristic adjustment circuit 22 performs arithmetic using the second correction coefficient, which has been read from the OTP 25. The output characteristic adjustment circuit 22 corrects a sensitivity difference between color components as illustrated in FIGS. 6 and 7.

The distance from center of the image may be an image height. The OTP 25 holds the second correction coefficient, which is set for every range of 5% or every range of 10% of the image height. The second correction coefficient, which is set for each range of the distance in the OTP 25, is further set for each range of color temperature.

The output characteristic adjustment circuit 22 reads the second correction coefficient corresponding to the distance from center of the image and the color temperature during imaging of the object image from the OTP 25. The output characteristic adjustment circuit 22 performs a correction of a color sensitivity difference based on the second correction coefficient, which has been read from the OTP 25, as well as an adjustment of the output characteristic based on the first correction coefficient.

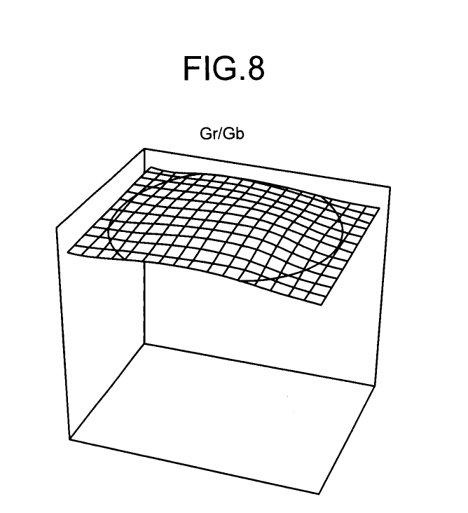

FIG. 8 is a view illustrating the sensitivity difference between the Gr pixel and the Gb pixel provided to the image sensor illustrated in FIG. 1. An illustrated curved surface represents distribution of sensitivity of the Gr pixel based on sensitivity of the Gb pixel. The sensitivity of the Gr pixel relative to the Gb pixel becomes slightly low as it is away from the center of the image.

The OTP 24 holds a table of the third correction coefficient, which is set for each range of the distance from center of the image. The GrGb correction circuit 21 performs arithmetic using the third correction coefficient, which has been read from the OTP 24 according to the distance. The GrGb correction circuit 21 corrects the sensitivity difference between the Gr pixel and the Gb pixel as illustrated in FIG. 8.

The OTP 24 holds the third correction coefficient, which is set for every range of 5% or every range of 10% of the image height. The third correction coefficient, which is set for each range of the distance in the OTP 24, is further set for each range of the color temperature.

The GrGb correction circuit 21 reads the third correction coefficient corresponding to the distance from center of the image and the color temperature during imaging of the object image from the OTP 24. The GrGb correction circuit 21 corrects the signal level of the green component based on the third correction coefficient, which has been read from the OTP 24.

In the image sensor 10, there may be a difference in signal output between the Gr pixel and the Gb pixel since a level of leakage of a signal due to crosstalk is different between the Gr pixel and the Gb pixel. In the image sensor 10, there may also be the sensitivity difference between the Gr pixel and the Gb pixel caused by variation in a pixel structure or manufacturing process.

In the solid state imaging device 5, due to an influence of this output difference between the Gr pixel and the Gb pixel, there may be a lattice-like noise caused in image processing such as demosaic processing. The GrGb correction circuit 21 decreases the sensitivity difference between the Gr pixel and the Gb pixel that causes such image quality deterioration.

According to the embodiment, the color mixture correction circuit 18, together with the adjustment based on the first correction coefficient, adjusts the signal level of each of the color components based on the second correction coefficient in the output characteristic adjustment circuit 22. The solid state imaging device 5 is capable of obtaining the output characteristic in which an influence of the sensitivity difference of each of the color components is decreased. The solid state imaging device 5 is capable of obtaining high color reproducibility as well as of improving the sensitivity thereof at the peak of the output characteristic.

The color mixture correction circuit 18 corrects the signal level of the green component for the Gr pixel and the Gb pixel based on the third correction coefficient in the GrGb correction circuit 21. The solid state imaging device 5 is capable of obtaining the output characteristic in which an influence of the sensitivity difference between the Gr pixel and the Gb pixel is decreased. The color mixture correction circuit 18 causes the noise reduction circuit 23 to decrease the noise component, which increases with the color mixture correction.

The solid state imaging device 5, by improving the output characteristic of each of the color components in the color mixture correction circuit 18, is capable of obtaining the high color reproducibility in the image processing. As described above, the solid state imaging device 5 exhibits an effect that an influence of the color mixture can be suppressed and a high quality image can be obtained.

Note that the color mixture correction circuit 18 is not limited to one provided with both of the GrGb correction circuit 21 and the noise reduction circuit 23. In the color mixture correction circuit 18, the GrGb correction circuit 21 may be omitted in a case where the correction corresponding to the sensitivity difference between the Gr pixel and the Gb pixel is not necessary. In a case where the noise reduction processing is not necessary, the noise reduction circuit 23 may also be omitted in the color mixture correction circuit 18.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid state imaging device comprising:
an image sensor provided with color pixels and configured to image an object image; and
a color mixture correction circuit configured to perform a color mixture correction on the object image, wherein
the color mixture correction circuit includes:
an adjustment circuit configured to adjust a relationship between a signal level and a wavelength of light of each color component from the image sensor based on a first correction coefficient for the color mixture correction; and
a memory configured to hold the first correction coefficient and a second correction coefficient corresponding to a sensitivity difference among the color pixels,
the memory is configured to hold the second correction coefficient set for each range of distance from center of an image, and
the adjustment circuit is configured to adjust the signal level of each of the color components based on the second correction coefficient, which has been read according to the distance.

2. The solid state imaging device according to claim 1, wherein
the image sensor is provided with a red pixel configured to detect red color light, a green pixel configured to detect green color light, and a blue pixel configured to detect blue color light, and
the color mixture correction circuit is provided with a green correction circuit configured to correct the signal level of a green component corresponding to the sensitivity difference between a first green pixel and a second green pixel, the first green pixel being the green pixel adjacent to the red pixel in a horizontal direction, the second green pixel being the green pixel adjacent to the blue pixel in the horizontal direction.

3. The solid state imaging device according to claim 2, wherein
the adjustment circuit is configured to adjust the signal levels of red and blue components and the signal level of the green component, which has been corrected by the green correction circuit.

4. The solid state imaging device according to claim 1, wherein
the memory is configured to hold the second correction coefficient set for each range of the distance and for each range of color temperature, and
the adjustment circuit reads the second correction coefficient corresponding to the distance and the color temperature during imaging of the object image from the memory.

5. The solid state imaging device according to claim 2, wherein
the color mixture correction circuit is provided with:
a first memory, which is the memory configured to hold the first correction coefficient and the second correction coefficient; and
a second memory configured to hold a third correction coefficient corresponding to the sensitivity difference between the first green pixel and the second green pixel,
the second memory is configured to hold the third correction coefficient set for each range of the distance, and
the green correction circuit is configured to correct the signal level of the green component based on the third correction coefficient, which has been read according to the distance.

6. The solid state imaging device according to claim 1, wherein
the color mixture correction circuit is provided with a noise reduction circuit configured to perform noise reduction processing on the object image, and
the noise reduction circuit is configured to perform the noise reduction processing on the object image, which has been through an adjustment of the signal level in the adjustment circuit.

7. A camera system comprising:
an imaging optical system configured to take in light from an object;
an image sensor provided with color pixels and configured to image an object image; and
a signal processing circuit configured to process a signal from the image sensor, wherein
the signal processing circuit is provided with a color mixture correction circuit configured to perform a color mixture correction on the object image,
the color mixture correction circuit is provided with:
an adjustment circuit configured to adjust a relationship between a signal level and a wavelength of light of each color component from the image sensor based on a first correction coefficient for the color mixture correction; and
a memory configured to hold the first correction coefficient and a second correction coefficient corresponding to a sensitivity difference among the color pixels,
the memory is configured to hold the second correction coefficient set for each range of distance from center of an image, and
the adjustment circuit is configured to adjust the signal level of each of the color components based on the second correction coefficient, which has been read according to the distance.

8. The camera system according to claim 7, wherein
the image sensor is provided with a red pixel configured to detect red color light, a green pixel configured to detect green color light, and a blue pixel configured to detect blue color light, and
the color mixture correction circuit is provided with a green correction circuit configured to correct the signal level of a green component corresponding to the sensitivity difference between a first green pixel and a second green pixel, the first green pixel being the green pixel adjacent to the red pixel in a horizontal direction, the second green pixel being the green pixel adjacent to the blue pixel in the horizontal direction.

9. The camera system according to claim 8, wherein
the adjustment circuit is configured to adjust the signal levels of red and blue components and the signal level of the green component, which has been through correction by the green correction circuit.

10. The camera system according to claim 7, wherein
the memory is configured to hold the second correction coefficient set for each range of the distance and for each range of color temperature, and
the adjustment circuit is configured to read the second correction coefficient corresponding to the distance and the color temperature during imaging of the object image from the memory.

11. The camera system according to claim 8, wherein
the color mixture correction circuit is provided with:
a first memory, which is the memory configured to hold the first correction coefficient and the second correction coefficient; and
a second memory configured to hold a third correction coefficient corresponding to the sensitivity difference between the first green pixel and the second green pixel,
the second memory is configured to hold the third correction coefficient set for each range of the distance, and
the green correction circuit is configured to correct the signal level of the green component based on the third correction coefficient, which has been read according to the distance.

12. The camera system according to claim 7, wherein
the color mixture correction circuit is provided with a noise reduction circuit configured to perform noise reduction processing on the object image, and
the noise reduction circuit is configured to perform the noise reduction processing on the object image, which has been through an adjustment of the signal level in the adjustment circuit.
